(19) United States
(12) Patent Application Publication
(10) Pub. No.: US 2023/0139667 A1
(43) Pub. Date: May 4, 2023

(54) Inferred Engine Cylinder Pressure System and Method

(71) Applicant: Caterpillar Inc., Peoria, IL (US)

(72) Inventors: William J. Barnes, Rapid City, SD (US); Eric D. Wiebrecht, Germantown Hills, IL (US)

(73) Assignee: Caterpillar Inc., Peoria, IL (US)

(21) Appl. No.: 17/514,753

(22) Filed: Oct. 29, 2021

(51) Int. Cl. F02D 35/02; F02D 41/00; F02D 41/24

(52) U.S. Cl. CPC F02D 35/024; F02D 41/0097; F02D 41/2451; F02D 2200/1004; F02D 2200/101

(57) ABSTRACT

A system and method includes a driver component having a first sensor rigidly mounted therewith and configured to provide a first signal indicative of a rotation of the driver component, and a second sensor rigidly mounted relative to the driver component, a driven component, and a flexible coupler disposed between the driver component and the driven component; wherein the second sensor provides a second signal indicative of a rotation of the driven component, and a controller disposed to receive the first signal and the second signal. The controller is configured and operates to calculate a difference between the first signal and the second signal, and infer a torque variation between the driver component and the driven component based primarily on the difference between the first signal and the second signal.

### TECHNICAL FIELD

This patent disclosure relates generally to internal combustion engines and, more specifically, to systems and methods of measurement or estimation of engine operating parameters.

### BACKGROUND

Internal combustion engines operate based on a controlled burning of an air and fuel mixture within one or more engine cylinders. Expanding gas trapped within the cylinder, and the pressure it produces, pushes onto a piston disposed in a bore, which in turn provides the work necessary to turn a crankshaft of the engine to produce power. Gas pressure within the engine cylinders is sometimes used to monitor the air/fuel burning progress to better control engine operation. This monitoring is especially useful when the chemical properties of the fuel provided to operate the engine is not known or uniform. For example, engines operating generators (gensets) in an environment where natural gas is used as a fuel to operate the engine may experience unreliable operation if the chemical makeup of the natural gas changes.

To ensure proper engine operation, various solutions have been proposed in the past for devices that can measure cylinder pressure in an operating engine. Some solutions propose use of pressure transducers placed directly in contact with the cylinder gases, but such solutions expose these sensors to extreme operating conditions and are generally unreliable or expensive to implement reliably. Indirect cylinder pressure measurements have also been proposed. For example, U.S. Pat. No. 7,623,955 to Rackmil et al. discusses a method for inferring Indicated Mean Effective Pressure (IMEP) in an engine by monitoring crankshaft rotation. The method disclosed in Rackmil includes acquiring at least one crankshaft time stamp for use in determining a cylinder-specific engine velocity; calculating an incremental change in engine kinetic energy from the previously fired cylinder (j-1st) to the currently fired (jth) cylinder using the cylinder-specific engine velocity; equating the incremental change in engine kinetic energy to a change in energy-averaged cylinder torque (IMEP) from the previously-fired (j-1st) to a currently-fired (jth) cylinder; summing a plurality of the incremental changes in engine kinetic energy over time to determine a value of the transient component of indicated torque; determining a value of the quasi-steady indicated engine torque; and adding the value of transient component of indicated torque to the value of quasi-steady indicated engine torque to yield the Indicated Mean Effective Pressure. However, Rackmil's method, while at least partially effective in estimating cylinder pressure, can also be susceptible to inaccuracy and depends on the rotation of the crankshaft, which is typically connected to a transmission and other rotating structures in a vehicle or machine, which can further introduce inaccuracies in the measurement method.

### SUMMARY

The disclosure describes, in one aspect, a drive arrangement between a driver and a driven system. The drive arrangement includes a rotatable driver component having first and second sensors associated therewith, the first sensor rigidly mounted relative to the rotatable driver component and configured to provide a first signal indicative of a rotation of the rotatable driver component. The arrangement further includes a rotatable driven component and a flexible coupler disposed between the rotatable driver component and the rotatable driven component. The second sensor is configured to provide a second signal indicative of a rotation of the rotatable driven component. A controller is disposed to receive the first signal and the second signal. The controller is configured to calculate a difference between the first signal and the second signal, and infer a torque variation between the rotatable driver component and the rotatable drive component based primarily on the difference between the first signal and the second signal.

In another aspect, the disclosure describes a genset that includes an engine having a plurality of cylinders, and a generator. Each of the plurality of cylinders of the engine is connected to and configured to drive a flywheel during operation of the engine. A first timing sensor is associated with the engine and provides an input signal indicative of rotation of the flywheel. A flexible coupling has an input side connected to the flywheel and an output side connected to an input shaft of a generator. The input shaft of the generator includes a tone ring. A second timing sensor is rigidly connected relative to the engine and is configured to provide an output signal indicative of a rotation of the tone ring. A controller is associated with the engine. The controller is disposed to receive the input signal and the output signal. The controller is programmed to calculate a difference between the input signal and the output signal, and infer a cylinder pressure in each of the plurality of cylinders based on the difference.

In yet another aspect, the disclosure describes a method for measuring a torque variation across a flexible coupler disposed between a rotatable driver component and a rotatable driven component. The method includes providing the flexible coupler between the rotatable driver and driven components, the flexible coupler having a driver side connected to the rotatable driver component and a driven side connected to the rotatable driven component. First and second sensors are provided and rigidly mounted relative to the driver side of the flexible coupler. Rotation of the rotatable driver component is sensed using the first sensor to provide a first signal. Rotation of the rotatable driven component is sensed using the second sensor to provide a second signal. A difference between the first signal and the second signal is calculated using a controller to infer a torque variation across the flexible coupler based on the difference between the first signal and the second signal.

### BRIEF DESCRIPTION OF THE DRAWINGS

FIG. 1 is an outline view of a genset in accordance with the disclosure.

FIG. 2 is a partial section view of the genset shown in FIG. 1, and FIG. 3 is an enlarged detail view thereof.

FIG. 4 is a front plan view of a portion of an engine around a flywheel ring gear in accordance with the disclosure.

FIG. 5 is a chart in accordance with the disclosure.

FIGS. 6 and 7 are detail views of a portion of an engine in accordance with the disclosure.

FIG. 8 is a flowchart for a method in accordance with the disclosure.

### DETAILED DESCRIPTION

This disclosure relates to management of engine systems and, more particularly, to systems and methods for the indirect measurement or, stated differently, the inference of cylinder pressure within combustion cylinders of an engine by use of external sensors.

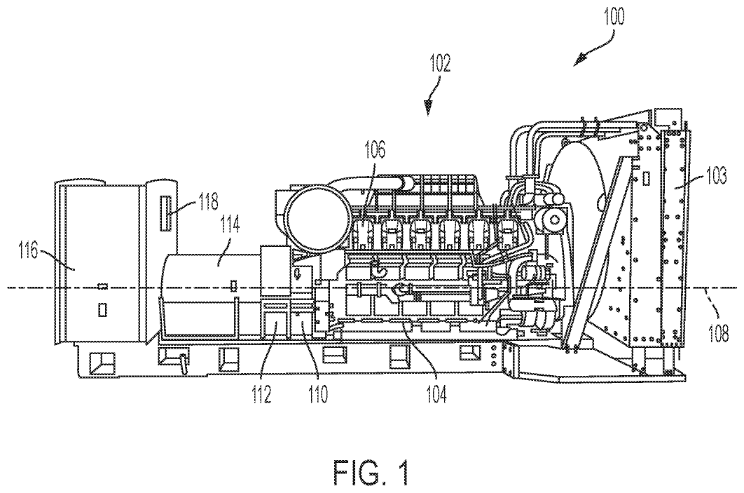

More specifically, in an exemplary embodiment, a genset 100 is shown in an outline view in FIG. 1. The genset 100 generally includes an engine 102, which in this embodiment is a gas or natural gas, spark ignition engine having 12 combustion cylinders 106 arranged in two rows in what's commonly referred to a Vee configuration along or within a cylinder case 104. The engine 102 can be any type of internal combustion engine including compression ignition engines operating with a single fuel, two fuels, a combination of diesel and a gaseous fuel, and the like in the known fashion. The engine 102 includes a cooling arrangement 103, for example, an intercooler, radiator, and the like, and internal to the cylinder case 104 includes a crankshaft (not shown) that is connected to pistons reciprocally disposed within the cylinders 106 and configured to rotate about an axis 108 during engine operation as the cylinders carry out a combustion cycle, for example, a 4 stroke cycle that includes an intake stroke, a compression stroke, a power stroke that provides power to turn the crankshaft, and an exhaust stroke, as is known.

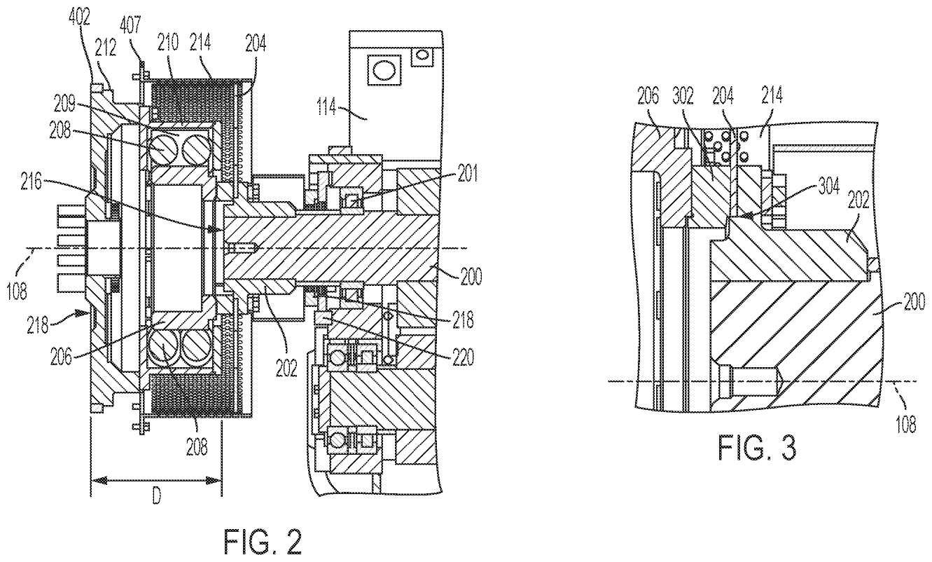

The crankshaft is connected to a flywheel 212 (FIG. 2) disposed within a coupling guard 110, which in turn is connected to a transmission 112. The transmission 112, which can also be omitted, is connected to and drives an electrical power generator 114 which converts mechanical energy from the engine to electrical power. The electrical power from the generator 114 can be used in many electrical or hybrid power applications. In one example, the genset 100 may be operating at an oil and gas facility either onshore or offshore such that excess gas byproducts can be used as a fuel, alone or in combination with another fuel, to operate the engine 102. The electrical power from the generator is used to operate equipment, provide motive power to propulsion systems, or a combination of the two. A switchgear 116 is connected to the generator 114 and operates to control and distribute the electrical power produced thereby. A controller 118 is configured to monitor and control the operation of the engine 102 and the generator 114 to optimal levels during service.

In the illustrated embodiment, the controller 118 is further configured to tune operation of the engine, for example, in terms of fuel quantity, ignition timing, power output and the like, based on the electrical needs of an electrical consumer system connected to the switchgear 116 and also based on changes of engine operation that are caused by differences in the chemical makeup of the natural gas used to fuel the engine 102. For example, a higher concentration of compounds having a lower octane rating may require retarding of engine ignition and injection timing, and correspondingly a lower quality fuel may require advancement of engine ignition and timing to avoid engine knocking during operation of the engine 102. Engine knocking, as is known, can cause inefficient engine operation because it involves uncontrolled burning of the air/fuel mixture provided to the cylinders 106, and can also increase stresses in engine components, which can increase wear and reduce component service life. To accomplish this, the controller 118 receives signals from sensors that are indicative of cylinder pressure within the cylinders of the engine. This cylinder pressure is measured indirectly based on rotational or angular differences or variations present at the engine to generator connection.

A partial section view through a portion of the engine 102 around a connection end of the flywheel 212 of the engine 102 with the generator 114 is shown in FIGS. 2 and 3. In reference to these figures, the flywheel 212 is connected through a coupling hub 206 to an input shaft 200 of the generator 114. The input shaft is supported by bearings 201 so it can rotate within a chassis, body or stator of the generator 114. At its end, the input shaft 200 of the illustrated embodiment includes a generator input flange 202 that is connected to a tone ring 204 and to a coupling hub 206, which in general has considerable mass and smooths rotational vibrations at the input of the generator 114.

The coupling hub 206 is elastically connected to an engine output flange 210 via elastomeric elements 208. The engine output flange 210 is connected to the flywheel 212 and is rotated thereby. Rotation of the flywheel 212 causes the output flange 210 to rotate, and the rotation is transferred to the coupling hub 206 connected to the generator input shaft 200 via elastomeric elements 208. The elastomeric elements 208, in a typical configuration, include compressible or stretchable elements in sections that can elastically deform peripherally around the coupling hub 206 and are retained in place by paddles 209 that extend radially or perpendicularly relative to the axis 108 between the coupling hub 206 and the engine output flange 210. Vibrations produced by bursts of power of a particular cylinder firing, or drains of power when another cylinder compresses cause continuous micro stretching and micro compressive stresses in the elastomeric elements 208 in a rotational or angular direction during engine operation. The elastomeric elements 208 also take up any minor axial misalignments between the flywheel 212 and the generator input shaft 200. A protective cover 214 is placed over and around the various rotating components, i.e., the tone ring 204, the flywheel coupling hub 206, the elastomeric elements 208, the engine output flange 210, and any other components that may be present in this area in this and other implementations.

The engine 102 further includes a timing gear formed peripherally around an outer portion of the flywheel 212 having teeth 402 (FIGS. 2 and 7) extending peripherally around the flywheel 212. The timing gear teeth 402 excite a crankshaft sensor or first timing sensor 406 that is mounted on the engine 102. Although the timing gear is shown mounted on the flywheel 212 it should be appreciated that it may be placed elsewhere in the engine, for example, on a camshaft or another structure that rotates without slipping along with the crankshaft while the engine is operating. During engine operation, the first timing sensor 406 provides information to the controller 118 that is indicative of the position and rotational speed of the crankshaft and flywheel 212 for use in controlling engine operation in the typical fashion.

As can be seen in the enlarged detail view of FIG. 3, the tone ring 204 can be sandwiched between the generator input flange 202 and the coupling hub 206 by use of a spacer ring 302, within an annular notch 304 formed in the generator input shaft 200, thus enabling installation of the tone ring 204 as a retrofit onto existing engines without increasing a distance, D, between an end face 216 of the generator input shaft 200 and an interface plane 218 of the flywheel 212 with the engine crankshaft (not shown).

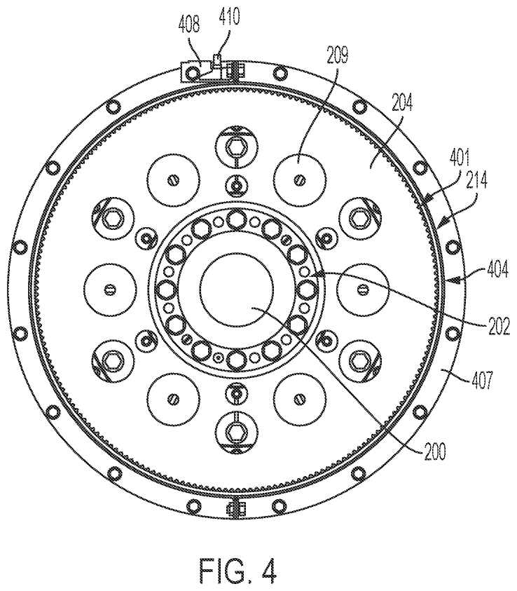

An outline view of the tone ring 204 as installed on the generator 114 is shown in FIG. 4. In this view, it can be seen that the tone ring 204 is generally circular and includes a plurality of teeth 401 along an outer periphery region 404 thereof. The protective cover 214 includes a flange 407 that is mountable onto the cylinder case of the engine around an area of the flywheel 212 (FIG. 2). A bracket 408 is connected to the flange 407 and supports a second timing sensor 410 thereon. The second timing sensor 410 is disposed to measure rotation of the tone ring 204 by sensing the location of the teeth 401 disposed along the tone ring 204 but, importantly, the second timing sensor 410 is mounted on the engine and the tone ring 204 is mounted on the coupling hub 206 opposite the elastomeric elements 208 such that the second timing sensor 410 can measure rotational variations of the elastomeric elements 208 present during engine operation compared to the engine and the flywheel 212. Stated differently, any rotational or angular deflection one way or the other of the elastomeric elements 208 causes a corresponding effect in the tone ring 204 and consequently in the readings of the second timing sensor 410 by creating a difference between the measurement of the flywheel rotation via the first timing sensor 406 measuring the teeth 402 on the flywheel 212 and the measurement of the tone ring 204 rotation via the second timing sensor 410 measuring the teeth 401 on the tone ring 204. This difference in measurement is proportional to the rotational or angular deflection of the elastomeric elements 208, which results from variations in the engine output torque caused by the various combustion strokes of the engine cylinders. In other words, when there is no rotational or angular deflection between the flywheel 212 and the tone ring 204, the measurements of the first timing sensor 406 and the second timing sensor 410 are substantially identical. These two measurements will diverge one way or the other (advanced or retarded relative to one another) depending on the direction of rotational or angular deflection of the elastomeric elements one way (compression) or the other (extension).

To illustrate, the sensor readings of the first timing sensor 406 on the engine and the second timing sensor 410 would or should be identical if there was a solid connection between the engine and the generator, i.e., if there were no elastomeric elements 208 used between the flywheel 212 and the generator input shaft 200. However, since the elastomeric elements 208 are present, their minute rotational or angular compression or stretching during engine operation caused by successive torque spikes or delays caused by cylinder operation will cause differences in the readings between the first and second timing sensors 406 and 410, which can also be referred to as an input sensor (the first timing sensor 406) to the flexible coupling between the engine and generator, and an output sensor (the second timing sensor 410). The terms input and output in this context refer to the input and output signal changes of any torque variations provided from the engine to the generator via the flexible coupling that includes the elastomeric elements 208.

The signals from both the input sensor 406 and the output sensor 410 are provided to the controller 118. The controller 118 monitors an input signal from the input sensor 406 and an output signal from the output sensor 410, calculates a difference between the two, and based on the difference between the input and output signals calculates or infers a cylinder pressure that is present concurrently with the measurements within the cylinders of the engine.

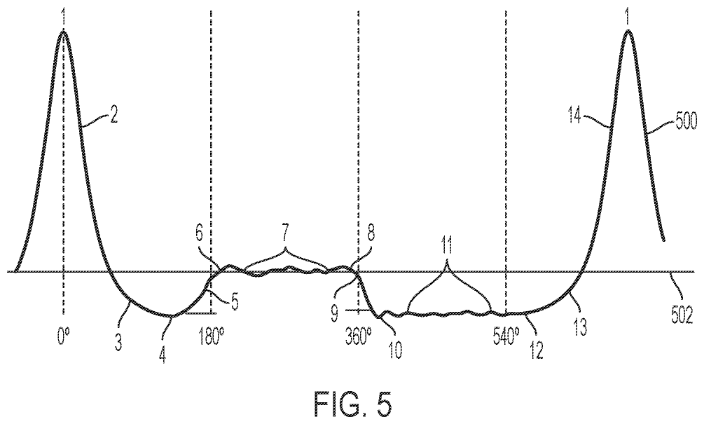

More specifically, a graph of the difference between the input and output signals over time for a single cylinder operating on the engine 102 is shown in FIG. 5. The curve 500 represents the value of the difference between the input signal provided by the input sensor or the first timing sensor 406, and the output signal provided by the output sensor or the second timing sensor 410. In essence, the magnitude of the vertical dimension of the curve 500 indicates the extent of rotational or angular deformation of the elastomeric elements 208 at any point in time, which time is plotted against the horizontal axis. The horizontal axis also represents a zero deflection of the elastomeric elements 208, so the direction of the curve 500 above or below the horizontal axis also indicates the direction of rotational or angular deflection of the elastomeric elements 208, with positive (above axis 502) indicating stretching of the elements 208, and negative (below the axis 502) indicating compression of the elements 208. As previously discussed, rotational or angular stretching of the elements 208 occurs when power or torque is input to the crankshaft in a rotational or angular direction tending to accelerate the flywheel 212 during a cylinder firing event or stroke, and rotational or angular compression of the elements 208 occurs when power or torque is stolen from the flywheel in a rotational or angular direction tending to decelerate the flywheel during a cylinder compression event.

In reference to FIG. 5, the trace of the input/output sensor signal difference is shown for a single cylinder and for a period between two successive power strokes. At a point 1 the cylinder is at peak cylinder pressure during a power stroke. Segment 2 represents a lowering of cylinder pressure during an expansion stroke after peak pressure. At segment 3 the cylinder continues expanding until point 4, and then begins compressing the exhaust gas during segment 5 until the cylinder exhaust valve(s) open at point 6. Exhaust gas is pushed out of the cylinder during a segment 7, and at point 8 the cylinder is at top dead center (TDC), the exhaust valves close, and the cylinder consumes work over a segment 99 until the intake valves open at point 10. The air or air and fuel mixture are pulled into the cylinder over segment 11 and consume work until the intake valves close at 12 and a compression stroke begins at segment 13. The compression stroke over segment 14 continues and combustion starts to increase cylinder pressure during the power stroke, which stretches the elements 208 and pulls the curve 500 towards the positive side, providing work and torque to the crankshaft until peak pressure is reached at a second point 1, and the cycle repeats.

It has been determined that the curve 500, or a parameter representing the difference between measurements taken by the first and second timing sensors 406 and 410 is a very accurate and reliable indicator of cylinder pressure. The difference parameter tracks cylinder pressure as well as a pressure sensor that is placed within the cylinder, but without requiring sophisticated sensor technologies such as piezo sensors that are configured to operate in the harsh in-cylinder environment. A reliable cylinder pressure determination can be made by using the outputs of the first and second timing sensors 406 and 410, one being the crankshaft sensor that is typically found on engines, and the other being a second sensor that is placed on the engine and measures rotation of a tone ring placed opposite the elastomeric elements 208.

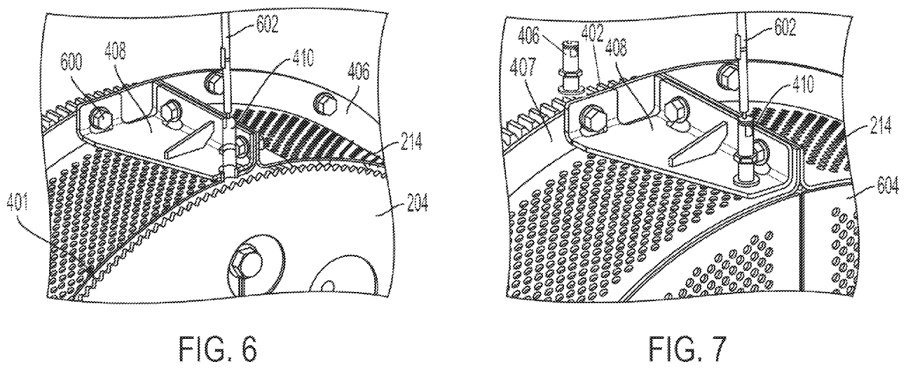

Illustrations of an exemplary embodiment for the placement of the second timing sensor 410 on an engine are shown in the detail views provided in FIGS. 6 and 7. As can be seen in these figures, the bracket 408 is mounted using fasteners 600 onto the engine cylinder case along the cover 214 such that the bracket 408 and, thus, the second timing sensor 410 supported thereby, are rigidly mounted onto the engine 102. The tone ring 204 is rigidly mounted on the input shaft 200 of the generator 114 and its teeth 401 excite the second timing sensor 410 so that the readings of the second timing sensor 410 will be affected by any compression or stretching of the elastomeric elements 208 when compared with corresponding readings of the teeth 402 on the flywheel 212 excite the first timing sensor 406. A cover plate 604 is placed over the exposed face of the tone ring 204. A conductor 602 can receive the signals from the second timing sensor 410 and communicate them to the controller 118.

### INDUSTRIAL APPLICABILITY

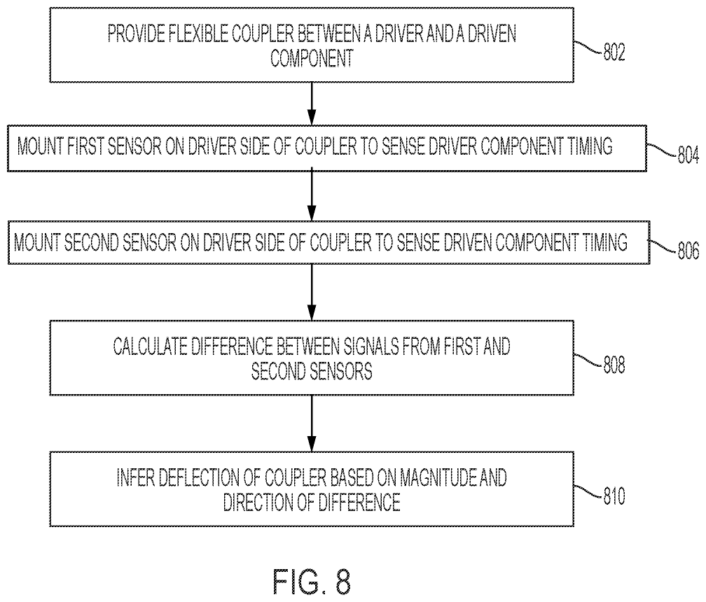

The present disclosure is applicable to internal combustion engines of any type that include a flexible coupling or connection between an engine output shaft and an input shaft of a driven system. A flowchart of a method of indirectly measuring cylinder pressure is provided in FIG. 8. In accordance with an embodiment, a flexible coupler is provided between a driver, such as an engine, and a driven component such as a generator at 802. The flexible coupler, for example, may include any type of flexible couplers including elastomeric elements placed between rotatable flanges that can compress or stretch depending on torque variations present between the rotating flanges.

A first sensor configured to sense rotation of a driver component is mounted on one side of the coupler that is rigidly associated with the driver component or system at 804. A second sensor is mounted on the same side of the coupler that is rigidly associated with the driver side of the system at 806. The second sensor is also configured to sense rotation of a tone ring mounted on the driven side of the coupler, or across the coupler, such that variations in the angular position of the coupler between the driver and driven components will affect the measurement of the second sensor relative to the first sensor. The difference between the first and second sensor signals is calculated at 808, and a rotational or angular deflection of the coupler is inferred at 810 based on the magnitude and direction of the difference. In one embodiment, the driver is an engine, the driven component is a transmission or generator, and the difference is indicative of cylinder pressure in the engine.

As can be appreciated, in an exemplary engine installation having rubber elastomeric couplings, the rotational or angular deflection of the measurement can be about 10 degrees. The controller can be programmed to calibrate the sensor difference at each startup, for example, when the engine is not carrying appreciable load, to account for various differences in the system that may affect measurements such as temperature, the hardness from weathering of the elastomeric elements, and the like. By measuring cylinder pressure during engine operation, the controller can control fuel and ignition timing, if applicable, when ignition requires delay or advancement as indicated by the cylinder pressure on the fly in the event engine operation changes, for example, due to inconsistent fuel quality. By measuring cylinder pressure in this fashion, other parameters such as burn duration, cylinder pressure rise rate, peak pressure, ignition timing and other parameters can also be calculated and used to optimize engine operation.

The tone ring 204, in one embodiment for an engine having 20 cylinders, can be arranged with 183 teeth. In such embodiment, the controller can effectively and accurately sense specific cylinder firings per engine revolution, or a trace that measures the location of about 18 teeth per firing, which provides sufficient resolution to infer the desired engine operating and cylinder firing parameters.

As can be appreciated, in the embodiment described herein two sensors are mounted onto the input side of a flexible coupling (the engine) and measure timing signals of two timing gears, one timing gear being disposed on the input side of the flexible coupling (the engine flywheel) and the other timing gear being disposed on the output side of the flexible coupling (the tone ring). In an alternative embodiment, the sensors may also be mounted onto the output side of the flexible coupling (the generator).

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A drive arrangement between a driver and a driven system, comprising:
a rotatable driver component having a first sensor and a second sensor associated therewith, the first sensor and the second sensor being rigidly mounted relative to the rotatable driver component, the first sensor being configured to provide a first signal indicative of a rotation of the rotatable driver component;
a rotatable driven component, wherein the second sensor is configured to provide a second signal indicative of a rotation of the rotatable driven component;
a flexible coupler disposed between the rotatable driver component and the rotatable driven component; and
a controller disposed to receive the first signal and the second signal the controller configured to:
calculate a difference between the first signal and the second signal, and
infer a torque variation between the rotatable driver component and the rotatable driven component based primarily on the difference between the first signal and the second signal.

2. The drive arrangement of claim 1, wherein the rotatable driver component is a component of an internal combustion engine, the rotatable driven component is an input shaft of a generator, and the rotatable driven component includes a tone ring, and wherein the second sensor is configured to provide the second signal that is indicative of rotation of the tone ring.

3. The drive arrangement of claim 2, wherein the torque variation is indicative of pressure within at least one cylinder of the internal combustion engine.

4. The drive arrangement of claim 1, wherein the rotatable driver component is a flywheel having a timing gear associated therewith.

5. The drive arrangement of claim 1, further comprising a tone ring connected to the rotatable driven component, wherein the second sensor is configured to measure rotation of the tone ring.

6. The drive arrangement of claim 1, wherein the rotatable driver component is a flywheel of an internal combustion engine, and wherein the rotatable driven component is an input shaft of an electric power generator.

7. The drive arrangement of claim 1, wherein the difference between the first and second signals is indicative of a stretching or a compression of elastomeric elements disposed as parts of the flexible coupler.

8. A genset, comprising:
an engine having a plurality of cylinders, each of the plurality of cylinders connected to and configured to drive a crankshaft connected to a flywheel during operation of the engine, the flywheel including a timing gear associated therewith;
a first sensor mounted on the engine, the first sensor providing an input signal indicative of rotation of the timing gear;
a flexible coupling having an input side connected to the flywheel, the flexible coupling having a tone ring connected to an output side, the flexible coupling further including elastomeric elements connected between the input side and the output side;
a generator connected to the output side of the flexible coupling;
a second sensor mounted on the engine, the second sensor providing an output signal indicative of rotation of an input shaft of the generator; and
a controller associated with the engine, the controller disposed to receive the input signal and the output signal, the controller being programmed to:
calculate a difference between the input signal and the output signal, and
infer a cylinder pressure in each of the plurality of cylinders based on the difference.

9. The genset of claim 8, wherein the difference is further indicative of a torque variation across the flexible coupling.

10. The genset of claim 8, wherein the first sensor is configured to sense rotation of the timing gear.

11. The genset of claim 8, further comprising a tone ring connected to the input shaft of the generator, wherein the second sensor is configured to sense rotation of the tone ring.

12. The genset of claim 8, further comprising a cover surrounding the flexible coupling, the cover mounted on the engine, wherein the second sensor is mounted on the cover.

13. The genset of claim 8, wherein the difference between the input signal and the output signal is indicative of a stretching or a compression of flexible elements disposed as parts of the flexible coupling.

14. A method for measuring a torque variation across a flexible coupler disposed between a rotatable driver component and a rotatable driven component, comprising:
providing the flexible coupler between the rotatable driver and driven components, the flexible coupler having a driver side connected to the rotatable driver component and a driven side connected to the rotatable driven component;
providing a first sensor rigidly mounted relative to the driver side of the flexible coupler;
sensing a rotation of the rotatable driver component using the first sensor;
providing a first signal that is indicative of the sensing using the first sensor;
providing a second sensor rigidly mounted relative to the driver side of the flexible coupler;
sensing a rotation of the rotatable driven component using the second sensor;
providing a second signal that is indicative of the sensing using the second sensor;
calculating a difference between the first signal and the second signal using a controller; and
inferring a torque variation across the flexible coupler based on the difference between the first signal and the second signal using the controller.

15. The method of claim 14, wherein the rotatable driver component is a flywheel of an internal combustion engine, and wherein the rotatable driven component is an input shaft of a generator.

16. The method of claim 15, wherein sensing the rotation of the rotatable driven component using the second sensor includes providing a tone ring disposed on the rotatable driven component, and wherein the second sensor senses rotation of the tone ring.

17. The method of claim 15, further comprising calculating a cylinder pressure in at least one cylinder of the internal combustion engine based on the torque variation across the flexible coupler.

18. The method of claim 14, further comprising a timing gear associated with the rotatable driver component, wherein the first sensor is configured to sense rotation of the timing gear.

19. The method of claim 14, wherein the flexible coupler includes one or more elastomeric elements, and wherein the difference between the first and second signals is indicative of a stretching or a compression of the elastomeric flexible elements.

20. The method of claim 14. wherein inferring the torque variation further includes calibrating the difference to account for changes in elastic properties of the flexible coupler over time or environmental conditions.
